(19) United States
(12) Patent Application Publication
(10) Pub. No.: US 2023/0237339 A1
(43) Pub. Date: Jul. 27, 2023

(54) SYSTEMS AND METHODS FOR GLOBAL OPTIMIZATION OF MATERIAL PROPERTIES

(71) Applicant: Toyota Research Institute, Inc., Los Altos, CA (US)

(72) Inventor: Jens Strabo Hummelshøj, Brisbane, CA (US)

(21) Appl. No.: 17/582,687

(22) Filed: Jan. 24, 2022

(51) Int. Cl. G06N 3/08; G06N 3/04

(52) U.S. Cl. CPC G06N 3/088; G06N 3/0481

(57) ABSTRACT

A machine learning system includes a processor and a memory communicably coupled to the processor. The memory stores an acquisition module, a mapping module, a machine learning module, a fitting module, and a minimization module that include instructions that when executed by the processor cause the processor to: select a training dataset, map the training dataset from an input space to an output space such that the mapped training dataset is convex; train a machine learning model to learn a convex function that approximates the mapped training dataset in the output space; learn a minimum of the convex function; map the minimum of the convex function to the input space; and predict, based at least in part on the minimum of the convex function mapped to the input space, an optimum material property value and a corresponding material composition.

### TECHNICAL FIELD

The present disclosure relates generally to machine learning of material properties and particularly to machine learning of material properties and discovery of new material compositions.

### BACKGROUND

The use of machine learning to assist in the discovery of new materials and/or identify properties of known materials through optimization, i.e., finding a set of inputs to an objective function that results in a maximum or minimum output from the objective function, is an ongoing field of research and development. And while finding an arbitrary local minimum or maximum can be relatively straight forward using known optimization methods, finding a global minimum or maximum of a function can be time and cost prohibitive since analytical methods are typically not available and numerical solution strategies often lead to excessive computation time and/or unacceptable error.

The present disclosure addresses issues related to machine learning and global optimization of material of material properties and discovery of new materials, and other issues related to machine learning.

### SUMMARY

This section provides a general summary of the disclosure and is not a comprehensive disclosure of its full scope or all of its features.

In one form of the present disclosure, a system includes a processor and a memory communicably coupled to the processor. The memory stores machine-readable instructions that, when executed by the processor, cause the processor to select a training dataset comprising a plurality of material compositions and tagged property values of a predefined material property and map the training dataset from an input space to an output space such that the mapped training dataset is convex. In some variations, the memory stores machine-readable instructions that, when executed by the processor, cause the processor to learn a convex function that approximates the mapped training dataset in the output space and learn a minimum of the learned convex function and map the minimum of the learned convex function to the input space. And in at least one variation, the memory stores machine-readable instructions that, when executed by the processor, cause the processor to predict, based at least in part on the minimum of the learned convex function mapped to the input space, an optimum material property value and a corresponding material composition.

In another form of the present disclosure, a machine learning system includes a processor and a memory communicably coupled to the processor. The memory stores an acquisition module with instructions that when executed by the processor cause the processor to select a training dataset from at least one of a candidate material dataset and a material properties dataset. Also, the training dataset includes a plurality of material compositions and a property value of at least one predefined material property for each of the plurality of material compositions. The memory also stores a mapping module, a machine learning module, a fitting module, and a minimization module with instructions that when executed by the processor cause the processor to: map the training dataset from an input space to an output space such that the mapped training dataset is convex; train a machine learning model to learn a Softmax-affine function that approximates the mapped training dataset in the output space; learn a minimum of the learned convex function using gradient descent; map the minimum of the learned convex function to the input space; and predict, based at least in part on the minimum of the learned convex function mapped to the input space, an optimum material property value and a corresponding material composition.

In still another form of the present disclosure, a method includes selecting a training dataset comprising a plurality of material compositions and tagged property values of a predefined material property and mapping the training dataset from an input space to an output space such that the mapped training dataset is convex. In some variations, the method further includes learning a convex function that approximates the mapped training dataset in the output space and learning a minimum of the learned convex function and map the minimum of the learned convex function to the input space. And in at least one variation the method includes predicting, based at least in part on the minimum of the learned convex function mapped to the input space, an optimum material property value and a corresponding material composition.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A shows a plot of material property values versus material composition for a hypothetical A-B material system with the material property values illustrating a dense dataset;

FIG. 1B shows a plot of material property values versus material composition for the hypothetical A-B material system with the material property values illustrating a sparse dataset;

FIG. 2 illustrates an example of a machine learning system for predicting material properties according to the teachings of the present disclosure;

FIG. 3A shows a plot of the material property values in FIG. 1A after being mapped to output space such that the mapped material property values are convex;

FIG. 3B shows a convex function approximating the mapped material property values in FIG. 3A and a minimum of the convex function determined via gradient descent; and

FIG. 4 shows a flow chart for a machine learning method using the system illustrated in FIG. 2 to predict a global optimization of at least one material property and according to the teachings of the present disclosure.

### DETAILED DESCRIPTION

The present disclosure provides a machine learning (ML) system and a ML method for predicting global optimization of at least one material property for a given material system and predicting at least one material composition based, at least in part, on the predicted global optimization. The ML system and ML method train a ML model to learn a convex function for at least one set of material property values mapped from an input space to an output space where the material property values exhibit a convex shape or form (also referred to herein simply as “convex”). The ML system and ML method train the ML model to learn a minimum of the convex function, e.g., using gradient descent, and the learned minimum is mapped back to the input space such that an optimized material property value and corresponding material composition are predicted based, at least in part, on the learned minimum. And in some variations of the present disclosure, the ML system and ML method generate or predict a new material composition with an optimized material property and/or optimum combination of two or more material properties. As used herein, terms such as “property” and phrases such as “material property”, “the property”, and “predicting the property” refer to a property exhibited by a material and a value for the property.

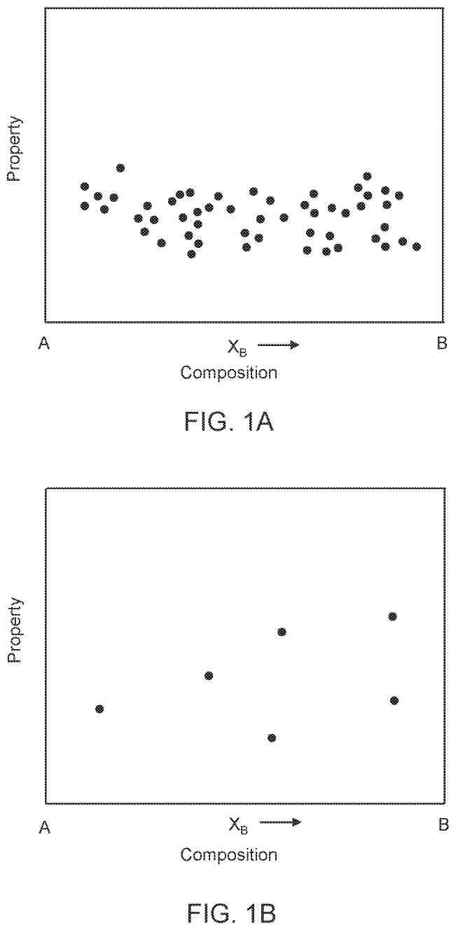

Referring to FIGS. 1A-1B, plots of two non-limiting examples of material property values as a function of material composition for hypothetical A-B material system are shown. Particularly, FIG. 1A shows a plot illustrating a relatively heavily populated dataset without a particular, shape, form or trend with increase in B content (X_{B}), and FIG. 1B shows a plot illustrating a relatively sparse dataset that appears to exhibit an increase in material property with increase in B content. And while the material property dataset in FIG. 1A may be used to determine an average material property value independent of B content, and the material property dataset in FIG. 1B may be used to determine a linear increasing relationship between the material property and B content, it should be understood that FIGS. 1A-1B represent plots where either determination would not provide desirable confidence in a calculated material property value as a function of material composition. It should also be understood that the plots shown in FIGS. 1A-1B do not lend themselves to discovering a material composition with an optimal material property value.

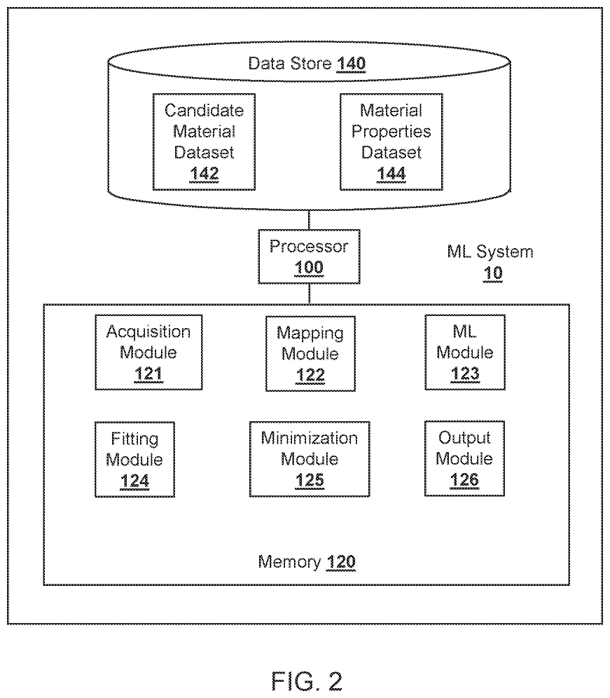

Referring now to FIG. 2, a ML system 10 for predicting a global optimum of at least one material property within a material system is illustrated. The ML system 10 is shown including at least one processor 100 (referred to herein simply as “processor 100”), and a memory 120 and a data store 140 communicably coupled to the processor 100. It should be understood that the processor 100 can be part of the ML system 10, or in the alternative, the ML system 10 can access the processor 100 through a data bus or another communication path.

The memory 120 is configured to store modules such as an acquisition module 121, a mapping module 122, a ML module 123, a fitting module 124, a minimization module 125 and an output module 126, among others. The memory is a random-access memory (RAM), read-only memory (ROM), a hard-disk drive, a flash memory, or other suitable memory for storing the acquisition module 121, mapping module 122, ML module 123, fitting module 124, minimization module 125 and output module 126 (referred to herein collectively as “modules 121-126”). Also, the modules 121-126 are, for example, computer-readable instructions that when executed by the processor 100 cause the processor to perform the various functions disclosed herein.

In some variations the data store 140 is a database, e.g., an electronic data structure stored in the memory 120 or another data store. Also, in at least one variation the data store 140 in the form of a database is configured with routines that can be executed by the processor 100 for analyzing stored data, providing stored data, organizing stored data, and the like. Accordingly, in some variations the data store 140 stores data used by the acquisition module 121, the mapping module 122, the ML module 123, the fitting module 124, the minimization module 125 and/or the output module 126. For example, and as shown in FIG. 2, in at least one variation the data store 140 stores a candidate material dataset 142 (also referred to herein simply as “candidate dataset 142”) and a material properties dataset 144. In some variations, the candidate dataset 142 includes a listing of a plurality of material compositions for at least one material system and the material properties dataset 144 includes a property value of at least one predefined property for at least a subset of the plurality of material compositions in the candidate dataset 142. It should be understood that the property values and the at least one predefined property in the material properties dataset 144 are properly tagged and/or associated with the plurality of material compositions in the candidate dataset 142.

Non-limiting examples of material systems in the candidate dataset 142 include materials such as polymers, metals, intermetallics, semiconductors, dielectrics, ionic liquids, solvents, electrolytes, and combinations thereof (e.g., ceramic matrix composites and metal matrix composites, among others). In some variations, the material properties dataset 144 includes a property value of a predefined material property for each of the plurality of material compositions in the candidate dataset 142, while in other variations the material properties dataset 144 includes a property value for at least two different predefined material properties for each of the plurality of material compositions in the candidate dataset 142. In at least one variation, the material properties dataset 144 includes a property value for at least three different predefined material properties for each of the plurality of material compositions in the candidate dataset 142, for example, four or more, five or more, or six and more different predefined material properties for each of the plurality of material compositions in the candidate dataset 142.

Non-limiting examples of predefined material properties in the material properties dataset 144 include electronic bandgap, electrical conductivity, thermal conductivity, acoustical absorption, acoustoelastic effect, surface energy, surface tension, capacitance, dielectric constant, dielectric strength, thermoelectric effect, permittivity, piezoelectricity, pyroelectricity, Seebeck coefficient, curie temperature, diamagnetism, hall coefficient, magnetic hysteresis, electrical hysteresis, magnetoresistance, maximum energy product, permeability, piezomagnetism, Young's modulus, viscosity, Poisson's ratio and density, among others.

The acquisition module 121 can include instructions that function to control the processor 100 to select a training dataset from the candidate dataset 142 and the material properties dataset 144. That is, the acquisition module 121 can include instructions that function to control the processor 100 to select a subset of material compositions from the candidate dataset 142 and corresponding property values for at least one predefined material property from the material properties dataset 144. In at least one variation, the acquisition module 121 includes instructions that function to control the processor 100 to select the training dataset by applying a training function to the candidate dataset 142. Non-limiting examples of the training function include instructions to select the training dataset based on a random selection and/or an expert analysis.

The mapping module 122 includes instructions that function to control the processor 100 to map the training dataset from an input space (e.g., see FIGS. 1A, 1B) to an output space where the training dataset is convex, and map at least a portion of the output space back to the input space. Stated differently, the mapping module 122 includes one or more invertible functions that function to control the processor 100 to map a dataset from an input space to convex in an output space, and vice versa. Non-limiting examples of functions in the mapping module that map the training dataset from the input space to convex in the output space include autoencoders, e.g., variational autoencoders or adversarial encoders, and recurrent neural networks, among others.

The fitting module 124 includes instructions that function to control the processor 100 to learn a convex function that fits or approximates the mapped training dataset in the output space. Non-limiting examples of the convex function include logarithmically convex functions such as Softmax functions and Quadratic functions, i.e., methods/functions known for convex regression and convex combination, and combinations thereof such as Softmax Quadratic functions. In one variation of the present disclosure, the convex function is a Softmax-affine function.

The minimization module 125 includes instructions that function to control the processor to learn a minimum of the learned convex function. In at least one variation the minimization module 125 includes instructions that function to control the processor to learn a minimum of the learned convex function using gradient descent during each of one or more iterations. It should be understood that the term “gradient descent” as used herein refers to a first-order optimization algorithm for finding a local minimum of a differentiable function by taking repeated steps in the opposite direction of the gradient of the function at the current point until a minimum gradient is determined.

The output module 126 includes instructions that function to control the processor to generate at least one material composition within the material system of the training dataset that is not included in the candidate dataset based, at least in part, on the learned minimum of the learned convex function.

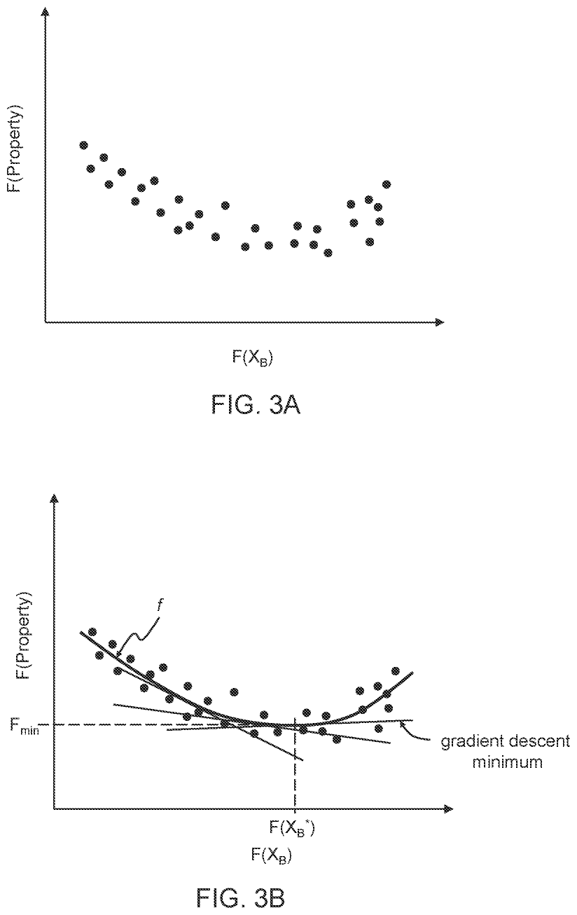

Training the ML model provides for predictions of at least one material composition with an optimized material property and/or an optimized combination of material properties. Particularly, and with reference to FIGS. 3A and 3B, the acquisition module 121 selects a training dataset from the candidate dataset 142 and material properties dataset 144 and the mapping module maps (i.e., instructs the processor 100 to map) the training dataset from an input space (e.g., see FIG. 1A) to an output space shown in FIG. 3A such that the mapped training dataset is convex. The fitting module 124 learns (i.e., instructs the processor 100 to learn) a convex function ‘ƒ’ that approximates the mapped training dataset as shown in FIG. 3B. As noted above, in some variations the convex function is the Softmax-affine function according to the equation:

$${f}_{SMA} ( x ) = \frac{1}{α} log {\sum }_{k = 1}^{K} exp ( α ( {b}_{k} + {a}_{k}^{T} x ) ) \qquad Eqn . 1$$

where ƒ_{SMA}(x) is the material property, x is material composition, and α, bₖ, and aₖ^{T} are fitting parameters.

The minimization module 125 determines a minimum “Fₘᵢₙ” of the convex function ‘ƒ’ as shown in FIG. 3B such that mapping of Fₘᵢₙ and the corresponding abscissa value or coordinate “F(X_{B}*)” back to the input space provides an optimized property value and corresponding material composition. And while FIGS. 1A, 3A and 3B illustrate mapping, minimization, and optimization in two dimensions, it should be understood that the ML system 10 is configured for mapping, minimization, and optimization in n dimension where n is an integer greater than 2. For example, in at least one variation the acquisition module 121 includes instructions that function to control the processor 100 to select a subset of material compositions from the candidate dataset 142 and a property value of two different predefined properties from the material properties dataset 144 for each of the material compositions such that the training dataset has three dimension data points and can be or is plotted in a three dimension input space. That is, each data point in the training dataset has coordinates of material composition, a property value for a first predefined material property, and a property value for a second predefined property value. Also, the mapping module 122 includes instructions that function to control the processor 100 to map the training dataset to convex in a three dimension output space, learn a three dimension convex function of the mapped training dataset, learn a minimum of the convex function, and map the minimum of the convex function and the corresponding material composition back to the three dimension input space in order to predict or provide a material composition with an optimum combination of the two material properties.

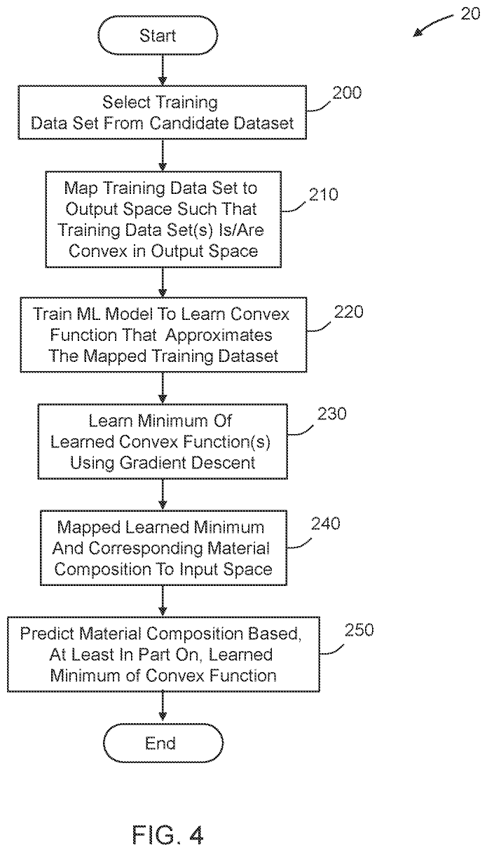

Referring now to FIG. 4, a flow chart for a ML method 20 is shown. The ML method 20 includes selecting a training dataset from a candidate dataset at 200 and mapping the training dataset from an input space to an output space such that the mapped training dataset is convex at 210. The ML 20 then trains a ML model to learn a convex function that approximates the mapped training dataset at 220 and learns a minimum of the convex function, e.g., using gradient descent, at 230. And the minimum of the convex function and a corresponding material composition are mapped back to the input space at 240 such that a material composition with an optimized material property or combination of different material properties is predicted at 250.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should be also understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A system comprising:
a processor; and
a memory communicably coupled to the processor and storing machine-readable instructions that, when executed by the processor, cause the processor to:
select a training dataset comprising a plurality of material compositions and tagged property values of a predefined material property;
map the training dataset from an input space to an output space such that the mapped training dataset is convex; and
learn a convex function that approximates the mapped training dataset in the output space;
learn a minimum of the learned convex function and map the minimum of the learned convex function to the input space; and
predict, based at least in part on the minimum of the learned convex function mapped to the input space, an optimum material property value and a corresponding material composition.

2. The system according to claim 1, wherein the convex function is a Softmax-affine function.

3. The system according to claim 2, wherein the Softmax-affine function is:
$${f}_{SMA} ( x ) = \frac{1}{α} log {\sum }_{k = 1}^{K} exp ( α ( {b}_{k} + {a}_{k}^{T} x ) )$$
where ƒ_{SMA}(x) is the property value for a predefined material property, x is material composition, and α, bₖ, and αₖ^{T} are fitting parameters.

4. The system according to claim 1 further comprising a minimization module with instructions that when executed by the processor cause the processor during each of one or more iterations to learn the minimum of the learned convex function using gradient descent.

5. The system according to claim 1, wherein the minimum of the convex function is a global minimum of the property value for the predefined material property of the training dataset.

6. The system according to claim 1 further comprising an output module including instructions that when executed by the processor cause the processor to generate, based at least in part on the optimum material property value, at least one material composition not included in the training dataset.

7. The system according to claim 6, wherein the output module comprises an autoencoder.

8. The system according to claim 1 further comprising a mapping module including instructions that when executed by the processor cause the processor to map the training dataset from the input space to convex in the output space using a logarithmic function.

9. The system according to claim 1, wherein the machine-readable instructions, when executed by the processor, cause the processor to select the training dataset from a material properties dataset, and the material properties dataset includes a property value for n predefined material properties for each of the material compositions in the training dataset, where n is an integer greater than 2, such that the training dataset comprises n dimension data points with coordinates of material composition and a property value for each of the n predefined material properties.

10. The system according to claim 9 further comprising a mapping module including instructions that when executed by the processor cause the processor to map the training dataset from an n dimension input space to an n dimension output space such that the mapped training dataset is convex in the n dimension output space.

11. The system according to claim 10 further comprising a mapping module, a machine learning module, a fitting module and a minimization module with instructions that when executed by the processor cause the processor to:
train a machine learning model to learn an n dimension convex function for the mapped training dataset in the n dimension output space;
determine a minimum for the learned n dimension convex function using gradient descent;
map the minimum of the learned n dimension convex function back to the n dimension input space; and
predict, based at least in part on the minimum of the learned n dimension convex function mapped back to the n dimension input space, a material composition with an optimum combination of the n predefined material properties.

12. The system according to claim 11 further comprising an output module including instructions that when executed by the processor cause the processor to generate, based at least in part on the material composition with the optimum combination of the n predefined material properties, at least one material composition not included in the training dataset.

13. The system according to claim 1, wherein the predefined material property is one of electronic bandgap, electrical conductivity, thermal conductivity, acoustical absorption, acoustoelastic effect, surface energy, surface tension, capacitance, dielectric constant, dielectric strength, thermoelectric effect, permittivity, piezoelectricity, pyroelectricity, Seebeck coefficient, curie temperature, diamagnetism, hall coefficient, magnetic hysteresis, electrical hysteresis, magnetoresistance, maximum energy product, permeability, piezomagnetism, Young's modulus, viscosity, Poisson's ratio and density.

14. A system comprising:
a processor; and
a memory communicably coupled to the processor, the memory storing:
an acquisition module including instructions that when executed by the processor cause the processor to select a training dataset from at least one of a candidate material dataset and a material properties dataset, wherein the training dataset includes a plurality of material compositions and a property value of at least one predefined material property for each of the plurality of material compositions;
a mapping module including instructions that when executed by the processor cause the processor to map the training dataset from an input space to an output space such that the mapped training dataset is convex; and
a machine learning module, a fitting module, and a minimization module including instructions that when executed by the processor cause the processor during each of one or more iterations, to:
train a machine learning model to learn a Softmax-affine function that approximates the mapped training dataset in the output space;
learn a minimum of the learned convex function using gradient descent, wherein the mapping module also includes instructions that when executed by the processor cause the processor to map the minimum of the learned convex function to the input space; and
predict, based at least in part on the minimum of the learned convex function mapped to the input space, an optimum material property value and a corresponding material composition.

15. The system according to claim 14, wherein the Softmax-affine function is:
$${f}_{SMA} ( x ) = \frac{1}{α} log {\sum }_{k = 1}^{K} exp ( α ( {b}_{k} + {a}_{k}^{T} x ) )$$
where ƒ_{SMA}(x) is the property value for a predefined material property, x is material composition, and α, bₖ, and aₖ^{T} are fitting parameters.

16. The system according to claim 15, wherein the minimum of the Softmax-affine function is a global minimum of the property value for the predefined material property of the training dataset.

17. The system according to claim 16, wherein:
the material properties dataset includes a property value for n predefined material properties for each of the material compositions in the training dataset, where n is an integer greater than 2, such that the training dataset comprises n dimension data points with coordinates of material composition and a property value for each of the n predefined material properties;
the mapping module includes instructions that when executed by the processor cause the processor to map the training dataset from an n dimension input space to an n dimension output space such that the mapped training dataset is convex in the n dimension output space; and
the mapping module, the machine learning module, the fitting module and the minimization module include instructions that when executed by the processor cause the processor to:
train the machine learning model to learn an n dimension convex function for the mapped training dataset in the n dimension output space;
determine a minimum for the learned n dimension convex function using gradient descent;
map the minimum of the learned n dimension convex function back to the n dimension input space; and
predict, based at least in part on the minimum of the learned n dimension convex function mapped back to the n dimension input space, a material composition with an optimum combination of the n predefined material properties.

18. The system according to claim 17 further comprising an output module including instructions that when executed by the processor cause the processor to generate, based at least in part on the optimum material property value, at least one material composition not included in the candidate material dataset.

19. A method comprising:
selecting a training dataset comprising a plurality of material compositions and tagged property values of a predefined material property;
mapping the training dataset from an input space to an output space such that the mapped training dataset is convex; and
learning a convex function that approximates the mapped training dataset in the output space;
learning a minimum of the learned convex function and map the minimum of the learned convex function to the input space; and
predicting, based at least in part on the minimum of the learned convex function mapped to the input space, an optimum material property value and a corresponding material composition.

20. The method according to claim 19, wherein the convex function is:
$${f}_{SMA} ( x ) = \frac{1}{α} log {\sum }_{k = 1}^{K} exp ( α ( {b}_{k} + {a}_{k}^{T} x ) )$$
where ƒ_{SMA}(x) is the property value for a predefined material property, x is material composition, and α, bₖ, and aₖ^{T} are fitting parameters.
